(19) United States
(12) Patent Application Publication
(10) Pub. No.: US 2021/0039492 A1
(43) Pub. Date: Feb. 11, 2021

(54) AN ELECTRIC AXLE ASSEMBLY

(71) Applicant: DONGFENG DANA AXLE CO., LTD., Xiangyang, Hubei (CN)

(72) Inventors: Tiankuo WANG, Xiangyang (CN); Shengli HU, Xiangyang (CN); Jiangjiang LUO, Xiangyang (CN); Junnan LU, Xiangyang (CN); Yun CHEN, Xiangyang (CN); Xuannan CHEN, Xiangyang (CN); Zhiying LIU, Xiangyang (CN); Guiwen TIAN, Xiangyang (CN)

(21) Appl. No.: 16/642,870

(22) PCT Filed: Aug. 31, 2018
(86) PCT No.: PCT/CN2018/103419

§ 371 Date: Feb. 27, 2020

(30) Foreign Application Priority Data
Aug. 31, 2017 (CN) 201710772617.9
Aug. 31, 2017 (CN) 201710774403.5
Aug. 31, 2017 (CN) 201710775694.X
Aug. 31, 2017 (CN) 201710775695.4
Aug. 31, 2017 (CN) 201721108027.8
Aug. 31, 2017 (CN) 201721108030.X
Aug. 31, 2017 (CN) 201721109238.3
Aug. 31, 2017 (CN) 201721110116.6

(51) Int. Cl. B60K 17/16; B60K 17/12; B60K 17/346

(52) U.S. Cl. CPC B60K 17/165; B60L 2220/42; B60K 17/346; B60K 17/12

(57) ABSTRACT

Provided herein is an electric axle assembly for a motor vehicle, including: an axle including a pair of axle half shaft and a pair of wheels drivingly connected on one end of each axle half shaft; a first electric motor/generator; and a gearbox including a reducing gear arrangement and a differential assembly, wherein the first electric/motor generator is drivingly connected to the gearbox, wherein the gearbox is drivingly connected to the axle, and wherein the differential assembly includes a differential housing and a differential gear arrangement disposed in the differential housing drivingly connected to the pair of axle half shafts.

### RELATED APPLICATIONS

This application claims priority to and benefit of Chinese Utility Model Application No. CN201721109238.3 on Aug. 31, 2017, Chinese Invention Application No. CN201710775695.4 filed on Aug. 31, 2017, Chinese Utility Model Application No. CN201721108030.x on Aug. 31, 2017, Chinese Invention Application No. CN201710775694.x filed on Aug. 31, 2017, Chinese Utility Model Application No. CN201721110116.6 filed on Aug. 31, 2017, Chinese Invention Application No. CN201710772617.9 filed on Aug. 31, 2017, Chinese Utility Model Application No. CN201721108027.8 filed on Aug. 31, 2017, and Chinese Invention Application No. CN201710774403.5 filed on Aug. 31, 2017 which are herein incorporated in by reference.

### FIELD

An electric axle assembly for a vehicle, such as for an electric vehicle, is described herein.

### BACKGROUND

At present, most electric vehicles are used in the power unit structure of a conventional internal combustion engine vehicles, i.e. motor, drive shaft, differential assembly. The conventional traditional structure of a transmission used in internal combustion engine vehicle is large and leads to efficiency losses. Additionally, the large size of each component making up the transmission will occupy space in the vehicle affecting the passenger capacity of the vehicle and the space available for the battery affecting the driving range of the vehicle.

To overcome the deficiencies of the prior art, the present invention provides a electric motor/generator, a gearbox and axle are integrated into a traditional electric machine axle assembly, such compact arrangement can be shortened transmission chain increase efficiency, improve passenger compartment and increasing the capacity of the battery capacity of the compartment, thereby reducing the energy consumption per unit mass of the carrier.

### SUMMARY

Provided herein is an electric axle assembly for a motor vehicle, including: an axle including a pair of axle half shaft and a pair of wheels drivingly connected on one end of each axle half shaft; a first electric motor/generator; and a gearbox including a reducing gear arrangement and a differential assembly, wherein the first electric/motor generator is drivingly connected to the gearbox, wherein the gearbox is drivingly connected to the axle, and wherein the differential assembly includes a differential housing and a differential gear arrangement disposed in the differential housing drivingly connected to the pair of axle half shafts.

In some embodiments, the first electric motor/generator and gearbox are arranged in parallel configuration.

In some embodiments, the first electric motor/generator is drivingly connected to the reducing gear arrangement and connected to an axial end of the gearbox.

In some embodiments, the electric axle assembly further includes a second electric motor/generator, wherein the first electric motor/generator and the second electric motor/generator are coupled to the gearbox on axially opposite sides thereof.

In some embodiments, first electric motor/generator, the second electric motor/generator and the gearbox arranged in parallel configuration.

In some embodiments, the reducing gear arrangement is drivingly connected to the first electric motor/generator and the differential assembly.

In some embodiments, the reducing gear arrangement includes a first spur gear, a double spur gear, and a second spur gear, wherein the first spur gear is drivingly connected to the first electric motor/generator and the double spur gear and wherein the second spur gear is drivingly connected to the differential assembly and the double spur gear.

In some embodiments, the second spur gear is mounted on the axle, and is coaxial with the axle half shafts.

In some embodiments, the second spur gear is installed on the differential housing and the second spur gear and axle half shafts are coaxial.

In some embodiments, the first electric motor/generator and the second electric motor/generator are positioned symmetrically on both axial sides of the gearbox using bolts and a flanged interface connected to the gearbox.

In some embodiments, the gearbox includes a motor interface provided on one axial side thereof.

In some embodiments, the first electric motor/generator and the gearbox are arranged in T-shape.

In some embodiments, the first electric motor/generator is connected to an axial side of the gearbox and the gearbox is attached to a central portion of the axle.

In some embodiments, the first electric motor/generator includes a rotor shaft having a hollow design with a central half shaft extending therethrough.

In some embodiments, the reducing gear arrangement includes a first-stage reducing gear, a central differential and a two-stage reducing gear arrangement.

### BRIEF DESCRIPTION OF DRAWINGS

Novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a schematic view of a preferred embodiment of an electric axle assembly;

FIG. 2 is a detailed cross-sectional view of the electric axle assembly of FIG. 1;

FIG. 3 is a schematic view of another preferred embodiment an electric axle assembly; and

FIG. 4 is a detailed cross-sectional view of the electric axle assembly of FIG. 3.

### DETAILED DESCRIPTION OF PREFERRED EMBODIMENTS

It is to be understood that the preferred embodiments may assume various alternative orientations and step sequences, except where expressly specified to the contrary. It is also to be understood that the specific assemblies, articles and features illustrated in the attached drawings, and described in the following specification are simply exemplary embodiments of the inventive concepts defined the appended claims. Hence, specific dimensions, directions, or other physical characteristics relating to the embodiments disclosed are not to be considered as limiting, unless expressly stated otherwise. Also, although they may not be, like elements in various embodiments may be commonly referred to with like reference numerals within this section of the application.

Provided herein is an electric axle assembly based on existing traditional axle power transmission structure having at least one electric motor/generator, a gearbox and a mechanical axle. The axle assembly eliminates the typical drive shaft and the main passive gear arrangement as the torque supplied from the electric motor/generator(s) is supplied to the wheel ends through the gearbox.

The axle assembly has compact structure, shortens the transmission chain, improves the transmission efficiency, enhances the passenger capacity of the compartment and increases the battery capacity of the compartment, thus reducing the energy consumption of the unit load quality, which has the characteristics of high dynamic output stability, compact weight reduction, increased compartment passenger space and battery layout space.

The invention integrates the functions of motor, reducer, transmission shaft and traditional mechanical axle in the driving unit of the traditional pure electric vehicle, and replaces them in structure and function.

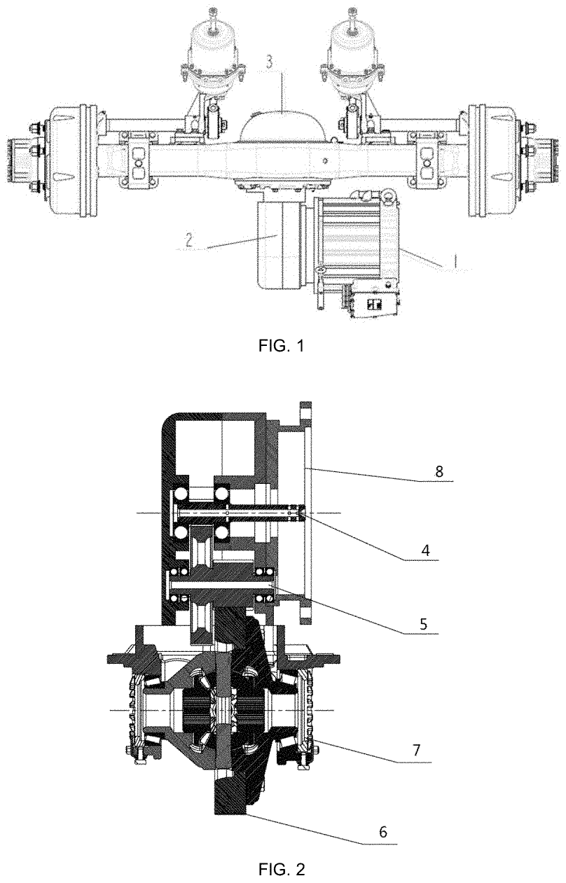

FIG. 1 depicts one preferred embodiment of the electric axle assembly having a mechanical axle 3, a first electric motor/generator 1 and a transmission/gearbox 2.

The axle can be of any type used for a motor-vehicle including a suspension-type vehicle axle as depicted in FIG. 1. In general, the axle includes a pair of wheels drivingly connected on one end of axle half shafts, respectively. It can be appreciated that the pair of wheels form a pair of driving wheels for the motor vehicle. In some embodiments, the vehicle may have a pair of front driving wheels, a pair of back driving wheels, or two pairs of front and back driving wheels.

The electric motor/generator(s) can be energized by electricity and output rotational movement and torque. In some embodiments, the electricity is provided by a battery pack. In some embodiments, the electric motor acts as an electric generator during brake operation of the electric vehicle for converting braking force into electricity.

In some embodiments, the gearbox 2 includes a two-speed transmission/reducing gear arrangement and a differential assembly.

In some embodiments, the differential assembly is a common differential gear set implemented to transmit rotational power. In some embodiments, the differential assembly includes a differential housing and a differential gear arrangement disposed in the differential housing with the two axle half shafts extending in axially opposites directions therefrom. The differential gear arrangement is drivingly connected to the axle half shafts respectively. In turn, the axle half shafts are drivingly coupled to wheels via suitable coupling means.

The electric motor/generator 1 has an output shaft capable of providing an input torque the gearbox 2 connected thereto.

The gearbox 2 has an output which supplies torque to two-wheel ends of the axle 3.

In some embodiments, a horizontal drive chain assembly arrangement is provided wherein a first drive torque of the electric motor/generator 1 is transmitted to both wheel ends of the axle 3 via the gearbox 2.

In some embodiments, as depicted in FIG. 1, the electric motor/generator 1 is attached to one axial side of the gearbox 2 while the other axle side of the gearbox 2 includes an additional mechanical interface.

In some embodiments, the additional mechanical interface allows for attachment of a second input torque to the gearbox 2.

In some embodiments, the electric motor/generator 1 and the gearbox 2 are connected using a flanged bolt connection.

In some embodiments, the axle 3, the first electric motor/generator 1 and the gearbox 2 are arranged parallel configuration.

FIG. 2 provides a detail view of one embodiment of the gearbox 2 of one embodiment of the electric axle assembly.

In some embodiments, the gearbox 2 includes a reducing gear arrangement and a differential assembly 7 integrated in a gearbox housing 8.

In some embodiments, the reducing gear arrangement includes a first cylindrical/spur gear 4, a double cylindrical/spur gear 5 and a second cylindrical/spur gear 6 which can provide two-stage speed ratio amplification. Other gear arrangement could be considered that provide the same two-stage speed ratio amplification.

In some embodiments, the connections between the gearbox 2 and the axle 3 provide that the second cylindrical gear 6 is installed on axle 3 on the differential housing of the differential assembly 7, thus, the second cylindrical gear 6 and the axle 3 are coaxial.

In some embodiments, the horizontal drive chain assembly of the gearbox provides a first drive torque input to both wheel ends of the axle 3 via the first electric motor/generators 1 and the gearbox 2.

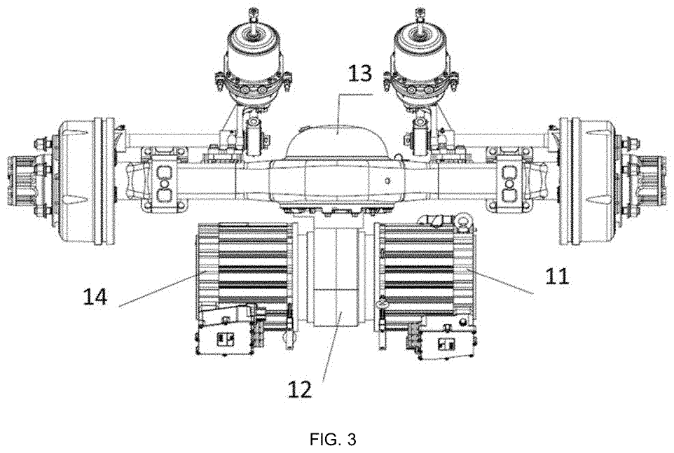

FIG. 3 depicts one preferred embodiment of a dual motor electric axle assembly including an axle 14, a first electric motor/generator 11, a second electric motor/generator 13 and a gearbox 12.

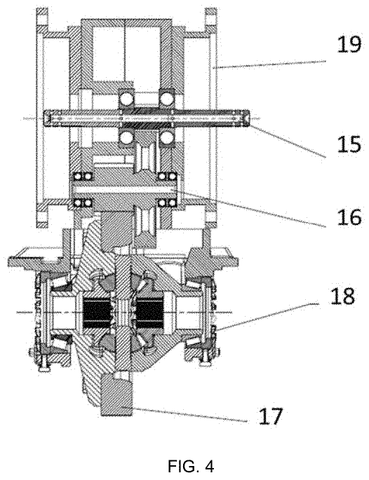

In some embodiments, the gearbox 12, as depicted in FIG. 4, provides a horizontal drive chain assembly arrangement wherein a first drive torque and a second drive torque are transmitted to both wheel ends of the axle 14 via first and second electric motor/generators 11, 13 and the gearbox 12.

In some embodiments, the gearbox 12 includes a reducing gear arrangement and a differential assembly 18 integrated in a gearbox housing 19.

In some embodiments, the reducing gear arrangement includes a first cylindrical/spur gear 15, double cylindrical/spur gear 16 and a second cylindrical/spur gear 17 as depicted in FIG. 4.

The first electric motor/generator 11 and the second electric motor/generator 13 transmit torque through the gearbox 12 and, after the two-stage ratio amplification, i.e. gears 15, 16, 17 and differential assembly 18, transmit torque to the axle 14 and wheel ends attached to both ends thereof.

In some embodiments the gearbox 12 includes two input torque connections which are operatively connected to both motor/generators 11, 13, respectively.

In some embodiments, the first electric motor/generator 11 and the second electric motor/generator 13 are positioned symmetrical on opposite sides of the gearbox 12 and attached thereto.

In some embodiments, the motor/generators 11, 13 are attached to the gearbox 12 using a flange interface and bolts.

The gearbox 12 is connected to and transmits an output torque to the axle 14.

In some embodiments, the second cylindrical gear 17 of the gearbox 12 is mounted on the differential housing of the differential assembly of the axle 14.

In some embodiments, the second cylindrical gear 17 is coaxial with the two-wheel ends of the axle 14.

In some embodiments, the axle 14, the first electric motor/generator 11, the second electric motor/generator 13 and the gearbox 12 are arranged by the parallel structure.

In another preferred embodiment of the electric axle assembly, the electric motor/generator 1 and the gearbox 2 are also composed in a split structure design. The electric motor/generator 1, gear box 2 and the axle 3 form a T-type arrangement. In this embodiment, the torque input of the gearbox 2 is located on the axial side of the gearbox 3 and the torque output is located on the axial end surface of the gearbox 2. The torque output of the gearbox 2 is connected with a center portion of the axle 3 such that is arranged in a T-shape. The axial opposite side of the gearbox 2 than the motor/generator 1 includes an additional interface to which an additional motor/generator can be attached according to customer demand.

In some embodiments, the electric motor/generator 1 has a rotor or output shaft attached thereto which transmits torque to the gearbox 2. In some embodiments, the rotor shaft of the motor/generator is hollow designed with a central half shaft.

In some embodiments, the motor/generator supplies torque into the front and rear axle of a vehicle through two central half axles of the motor shaft to achieve a four-wheel drive function. In some embodiments, the gearbox 2 includes first-stage reducing gear 4, a central differential arrangement 5, a two-stage reducing gear arrangement 6 and an inter-axial differential 7. This arrangement allows a vehicle including the axle assembly to have both four-wheel drive and two-wheel drive operating modes.

The gearbox and differential arrangement provide the function of a central differential and wheel differential speed, which enables vehicle to switch between four-wheel drive mode and two-wheel drive mode according to the demand.

Therefore, the electric motor/generator 1 provides torque to the front and rear axles through the two central half axles of the motor shaft for a four-wheel drive mode of the vehicle or locks the central differential 5 according to the demand for a two-wheel drive mode of the vehicle. Various differential locking mechanisms can be used to lock the central differential. Therefore, the axle assembly can freely switch the left and right wheel distribution of the torque and reduce the power loss according to the instructions of the whole vehicle controller.

In some embodiments, the operation of the axle assembly is controlled by a controller (not shown) connected thereto. The controller may be the vehicle ECU (electronic control unit), a sub-module in the vehicle ECU, an individual controller communicated with the vehicle ECU or the like. The controller can receive commands from the operator of the motor vehicle including information about operations to the gearshift, the acceleration pedal and other pedals as well as other related information, and then controls the electric motor/generators to rotate in a desired direction at a desired speed.

Additionally the locking of the central differential to switch between a four-wheel drive and two-wheel drive modes of operation are controlled by the ECU in response to the commands from the operator of the motor vehicle and vehicle running conditions according to at least one vehicle parameter, including but not limited to wheel speeds, etc.

In accordance with the provisions of the patent statutes, the present device has been described in what is considered to represent its preferred embodiments. However, it should be noted that the device can be practiced otherwise than as specifically illustrated and described without departing from its spirit or scope.

1. An electric axle assembly for a motor vehicle, comprising:
an axle including a pair of axle half shaft and a pair of wheels drivingly connected on one end of each axle half shaft;
a first electric motor/generator; and
a gearbox including a reducing gear arrangement and a differential assembly,
wherein the first electric/motor generator is drivingly connected to the gearbox,
wherein the gearbox is drivingly connected to the axle, and
wherein the differential assembly includes a differential housing and a differential gear arrangement disposed in the differential housing drivingly connected to the pair of axle half shafts.

2. The electric axle assembly of claim 1, wherein the first electric motor/generator and the gearbox are arranged in parallel configuration.

3. The electric axle assembly of claim 1, wherein the first electric motor/generator is drivingly connected to the reducing gear arrangement and connected to an axial end of the gearbox.

4. The electric axle assembly of claim 1, further comprising a second electric motor/generator, and wherein the first electric motor/generator and the second electric motor/generator are coupled to the gearbox on axially opposite sides thereof.

5. The electric axle assembly of claim 4, wherein the first electric motor/generator, the second electric motor/generator and the gearbox arranged in parallel configuration.

6. The electric axle assembly of claim 1, wherein the reducing gear arrangement is drivingly connected to the first electric motor/generator and the differential assembly.

7. The electric axle assembly of claim 1, wherein the reducing gear arrangement includes a first spur gear, a double spur gear, and a second spur gear, wherein the first spur gear is drivingly connected to the first electric motor/generator and the double spur gear and wherein the second spur gear is drivingly connected to the differential assembly and the double spur gear.

8. The electric axle assembly of claim 7, wherein the second spur gear is mounted on the axle, and is coaxial with the axle half shafts.

9. The electric axle assembly of claim 1, wherein the second spur gear is installed on the differential housing and wherein the second spur gear and axle half shafts are coaxial.

10. The electric axle assembly of claim 4, wherein the first electric motor/generator and the second electric motor/generator are positioned symmetrically on both axial sides of the gearbox using bolts and a flanged interface connected to the gearbox.

11. The electric axle assembly of claim 1, wherein the gearbox includes a motor interface provided on one axial side thereof.

12. The electric axle assembly of claim 1, wherein the first electric motor/generator and the gearbox are arranged in T-shape.

13. The electric axle assembly of claim 13, wherein the first electric motor/generator is connected to an axial side of the gearbox and the gearbox is attached to a central portion of the axle.

14. The electric axle assembly of claim 1, wherein the first electric motor/generator includes a rotor shaft having a hollow design with a central half shaft extending therethrough.

15. The electric axle assembly of claim 1, wherein the reducing gear arrangement includes a first-stage reducing gear, a central differential and a two-stage reducing gear arrangement.
